(19) United States
(12) Patent Application Publication
(10) Pub. No.: US 2014/0214522 A1
(43) Pub. Date: Jul. 31, 2014

(54) METHODS AND SYSTEMS FOR PROVIDING ONLINE EVENTS

(71) Applicants: Robert Alan Skollar, New York, NY (US); David Joel Freilicher, New York, NY (US)

(72) Inventors: Robert Alan Skollar, New York, NY (US); David Joel Freilicher, New York, NY (US)

(21) Appl. No.: 14/168,919

(22) Filed: Jan. 30, 2014

Related U.S. Application Data
(60) Provisional application No. 61/758,614, filed on Jan. 30, 2013.

(51) Int. Cl. G06Q 50/00; G06Q 30/02

(52) U.S. Cl. CPC G06Q 50/01; G06Q 30/0269
USPC 705/14.39; 705/14.66

(57) ABSTRACT

Exemplary embodiments of a method and system for providing an online event that can be customizable are provided. In some examples, a method can be provided including the steps of configuring a server to allow one or more users access to an online event having a specific date and time, configuring the server to allow a third party to provide event information to the one or more users related to the online event, and providing the event information from the third party to the one or more users regarding the online event at the specific date and time.

### CROSS-REFERENCE TO RELATED APPLICATION(S)

This application relates to and claims priority from U.S. patent application Ser. No. 61/758,614 filed Jan. 30, 2013, the entire disclosure of which is hereby incorporated herein by reference.

### FIELD OF THE DISCLOSURE

The present disclosure relates to exemplary embodiments of methods and systems for providing on-line events, and more particularly, to exemplary embodiments of methods and systems for providing on-line events that can be individually tailored and customized to a particular product or service.

### BACKGROUND INFORMATION

Internet usage has been mainly driven by portals and search engines. Recently, the rapid growth of social networking sites has revealed a new trend of Internet usage. Social networking generally relates to services and tools that help users maintain and expand their circles of friends usually by exploiting existing relationships. Social networking sites have shown potential to become the places on the Internet where many people spend most of their time, thus becoming one of the top platforms for online activity. Often, these social networking sites can become the focal point of sharing information, such as links, multimedia, music, and the like.

In general, social networking sites and other online services of the Internet offer a mix of features and tools, such as message boards, games, journals or web logs (“blogs”). Many of these sites try to build communities around multi-media or popular culture, such as television, film, music, etc. These sites and their features are designed to keep users clicking on advertising-supported pages of the site. Thus, the known social networking sites employ a closed platform of services that attempt to keep their user-base captive to the site.

Thus, there exists a significant platform for advertisers and companies to determine consumer needs and create content specific for particular users.

### BRIEF DESCRIPTION OF THE DRAWINGS

The foregoing and other exemplary objects of the present disclosure will be apparent upon consideration of the following detailed description, taken in conjunction with the accompanying exemplary drawings and claims, in which like reference characters refer to like parts throughout, and in which:

FIG. 1 is an illustration of an exemplary embodiment of a system according to the present disclosure; and

FIG. 2 is an illustration of an exemplary embodiment of a system according to the present disclosure.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject disclosure.

### SUMMARY OF EXEMPLARY EMBODIMENTS OF THE DISCLOSURE

At least some of the above described problems can be addressed by exemplary embodiments of the methods, systems and computer accessible medium according to the present disclosure. The present disclosure describes exemplary embodiments of methods and systems that can provide for a complete built-out social media platform, which can be coupled with marketing professional know-how in service of creating online events. These online events can be invite-only curated and custom-designed around the respective sponsors brand essence and specific marketing needs. Each event can offer privileged access and special personalized content to guests of the event. These events can stimulate engagement from user-to-user, brand-to-user and/or brand-brand. These events can activate a user's passion, reinforce their preference and create a deeper connection with the brand/sponsor of the event.

For example, using such exemplary embodiments, it is possible to provide a method of providing an online event, comprising configuring a server to allow one or more users access to an online event having a specific date and time, configuring the server to allow a third party to provide event information to the one or more users related to the online event, and providing the event information from the third party to the one or more users regarding the online event at the specific date and time.

The method can further comprise configuring the server to provide the third party an ability to interact with the one or more users during the online event at the specific date and time. The method can further comprise configuring the server to allow the third party to provide event information prior to the online event, and storing the event information in a database. The method can further comprise providing the event information to the one or more users from the database prior to the online event. The method can further comprise configuring the server to allow the one or more users to register for the online event before the online event takes place.

Profile information for the one or more users can be generated from one or more social media sites. The one or more users can interact with each other through text, audio and/or video before, during and after the online event. The method can further comprise providing reward information to the one or more users for a particular user after the online event has taken place. The third party can be a company and the online event can be regarding a product of the company.

Using such exemplary embodiments, it is also possible to provide a system for providing an online event, comprising a database for storing information relating to one or more users and an online event having a specific date and time, and a server for receiving event information from a third party relating to the online event and for providing the one or more users the event information from the third party at the specific date and time.

Event information from the third party can be stored in the database prior to the online event. The server can provide the event information from the database to the one or more users prior to the online event. The server can allow the one or more users to interact with each other through text, audio and/or video before, during and after the online event. The database can store profile information relating to the one or more users from one or more social media sites. The server can provide reward information relating to the online event after the online event has taken place. The server can provide the third party an ability to interact with the one or more users during the online event at the specific date and time.

Using such exemplary embodiments, it is also possible to provide a computer-accessible medium which contains thereon software for providing an online event, wherein, when a processing arrangement executes the software, the processing arrangement is configured to perform procedures comprising configuring a server to allow one or more users access to an online event having a specific date and time, configuring the server to allow a third party to provide event information to the one or more users related to the online event, and providing the event information from the third party to the one or more users regarding the online event at the specific date and time.

The processing arrangement can be further configured to provide the third party an ability to interact with the one or more users during the online event at the specific date and time. The processing arrangement can be further configured to allow the third party to provide event information prior to the online event, and store the event information in a database. The processing arrangement can be further configured to provide the event information to the one or more users from the database prior to the online event.

These and other objects, features and advantages of the present disclosure will become apparent upon reading the following detailed description of embodiments of the present disclosure, when taken in conjunction with the appended claims.

### DETAILED DESCRIPTION OF EXEMPLARY EMBODIMENTS OF DISCLOSURE

Exemplary embodiments of the methods and systems according to the present disclosure are described below.

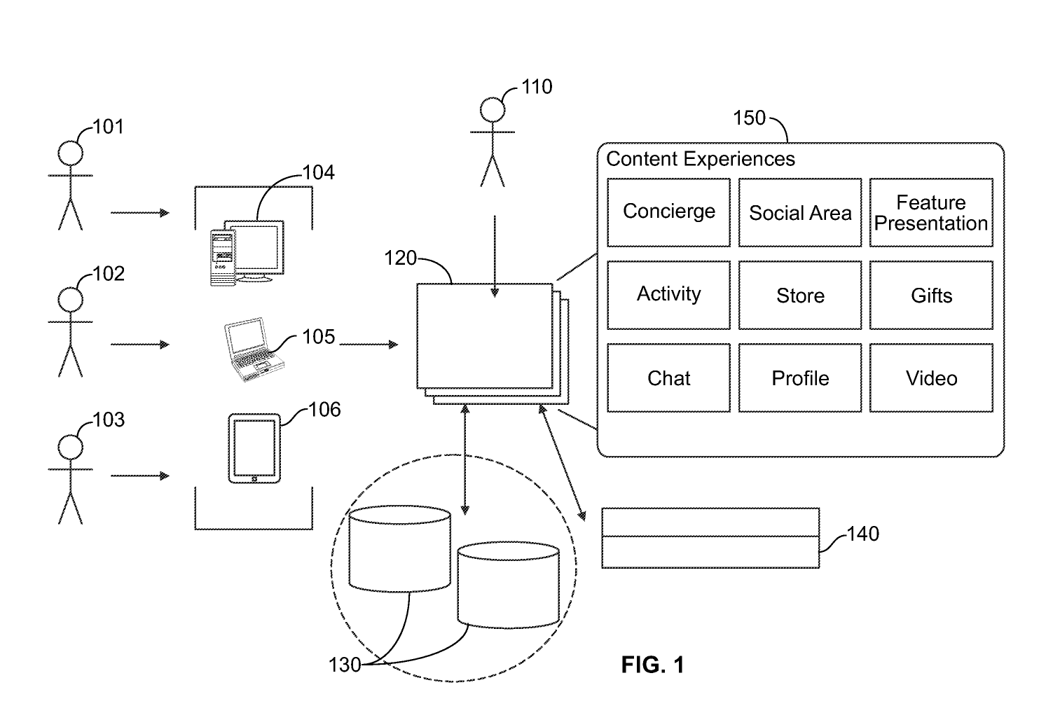

FIG. 1 is an illustration of an exemplary embodiment of a system according to the present disclosure. One or more users, 101, 102, 103 can use an electronic device to view an online event 120. The electronic device can be any type of device with an Internet capability, such as a PC 104, Laptop 105, Tablet 106, a smartphone, etc. The online event can be any type of event relating to any topic of interest for a third party 110, and can have a specific date and time that it starts. The third party 110 can be a person, business, entity, party, group, etc., which may have interest in providing an online event related to any number of topics, such as a product, a cause, an interest, or any other type of topic that would be of interest to provide to a number of users.

The users can have a profile stored in a database 130 prior to the online event. The users can register for the online event prior to the online event. The users can provide their profile information from outside systems 140, such as one or more social media sites, directly to the server (e.g., Facebook®, Twitter®, LinkedIn®). The profile information can be stored in the database 130, as well as the registration of the one or more users for each online event. The users can interact with each other through text, audio and/or video before, during and after the online event 120. The number of users for each online event is not limited, and can be one user or several hundred for each online event.

The online event 120 can be provided on a display of the electronic device of the particular user. The online event can be fully customizable by the third party 110. For example, the third party 110 can provide for the display of the electronic device to show (but not limited to) one or more of the following: a product, other users, information relating to the online event, a “room” or scene so that the user feels they are in a particular setting, a background, audio, video, etc. The actual screen display provided to the user can be fully customizable. The user can also choose what they want to see on their display, such as other users registered to the online event, their profile, any chat with one or more users, or sharing audio/video. The third party can also set up rules such that some data is configurable by the user and some is automatically displayed during the online event such that the user can not remove it from their display.

The third party 110 can provide event information related to the online event 120 that is stored in the database 130 prior to the online event 120. Such information can be provided to the users before the online event, or at a predetermined time (e.g., half hour before the online event is scheduled to take place). Various content experiences 150 can be provided on the display of the user (e.g., in the form of icons) during the online event 120, such as a user profile, audio/video/chat boxes, gifts/rewards provided to the users, a store, recent activity, a “presenter” during the online event, a feature presentation, etc. The activity or the type of content is not limited to any particular activity or content. After the online event is over, the third party can provide gift rewards to one or more users for viewing the online event (e.g., coupons, discounts on products, free samples, etc.). For example, users viewing the entire online event, users who answered more questions, and/or who were more interactive can get extra points as a reward.

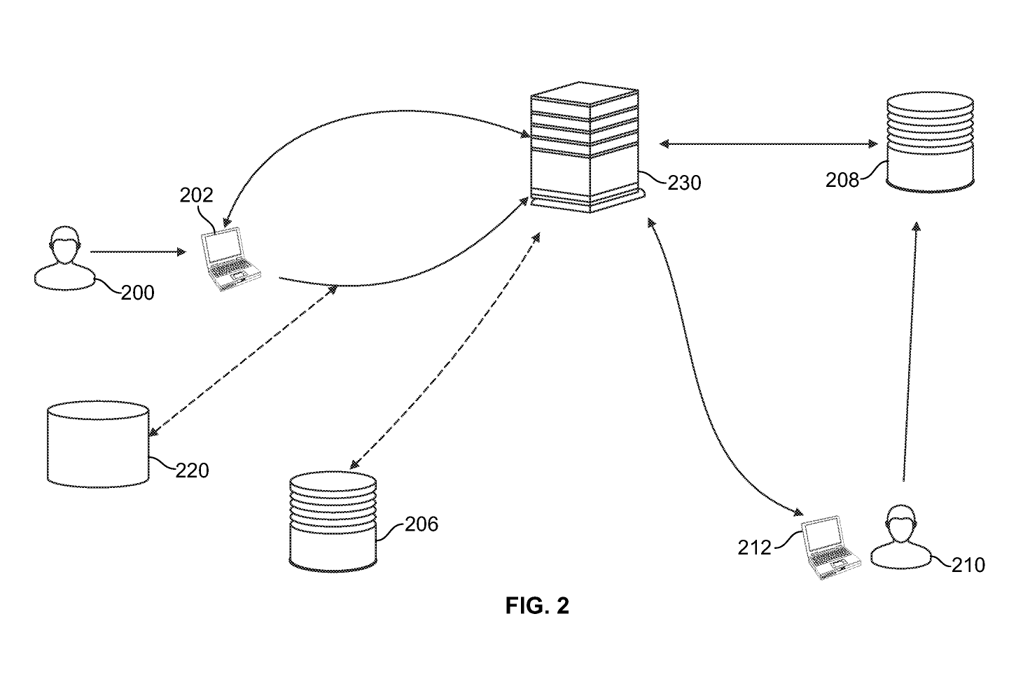

FIG. 2 is an illustration of another exemplary embodiment of a system according to the present disclosure. A user 200 can use an electronic device 202 to register for the online event, and log into the online event at the specific date and time of the online event. A server 230 receives this information and provides the online event and event information to the user 200. The user 200 can create a profile and/or upload their profile information from an outside API 220, such as a social media site. The user can register for the online event ahead of time. The profile information and user's registration can be received by the server 230 and stored in the database 206.

A third party 210 can use an electronic device 212 to provide an online event and provide details of the online event. For example, a person or company may want to provide an online event to one or more users at a specified date and time. This information is submitted to the server 230 and stored in database 208. The third party 210 can provide event information prior to the online event, and this information can be stored in database 208. This event information can be provided to one or more users registered for the online event prior to the online event. The third party 210 can provide event information to be displayed during the online event prior to the online event, that can be stored in database 208, and can also provide event information through the server 230 live during the online event that is provided to the one or more users registered for the online event. The third party can set rules for the online event, such as format, content, duration, etc. prior to the online event, which can be stored in database 208. During the online event, the server 230 can provide event information from the database 208 to the one or more users, as well as information live from the third party 210 to the one or more users. Event information can include but is not limited to text, audio, video and any other content related to the online event the third party 210 desires to provide to the one or more users registered for the online event. The server 230 can provide the third party an ability to interact with the one or more users during the online event at the specific date and time. After the online event is over, the server 230 can provide other information, such as reward information for attending the online event, to the one or more users from the third party 210.

In some exemplary embodiments of the present disclosure, the online event can be provided that can be built on top of, e.g., the Drupal 7 platform, an open source content management system written in PHP. It can be integrated with a social networking site, such as Facebook® (by, e.g., using the Facebook JavaScript SDK), LinkedIn® , including but not limited to other open source communities, and can provide live video (e.g., streaming, one on one chat, and group chat using, e.g., the Red5 Media Server). The platform can be OS independent, and can be hosted on a cloud (e.g., the Rackspace Cloud) using a standard LAMP setup (e.g., Linux, Apache, MySQL, PHP) that can be scaled indefinitely. The exemplary database can run on infrastructure such as Rackspace's Cloud DB infrastructure.

The exemplary online events can have many particular users. For example, there can be several go-to-market audiences and applications for such events, including brand to consumer, content creators for brand to consumer, research companies for brand to consumer, intra-business team building, inter-business (e.g., internal meeting for a company), and hosts of real world consumer events. The exemplary online events can also serve as a second screen accompanying a televised program, and can have the televised program embedded with the online event.

Several steps can be involved in creating an online event. For example, in preparing for the event, a brand audit can be conducted to determine marketing objectives, review sponsors' creative content inventory, and determine the budget and scope of the effort. Efficiencies can be ascertained that can be gleaned from existing sponsor resources and it can be determined how much original work/creative is required vs. certain turnkey efforts that are already built.

The topic can range for the online event, such as new insights on a brand, behavioral issues, relative appeal of new marketing initiatives a brand maybe considering, new packaging/naming alternatives, etc. Tools can be provided to reach the goals sought by the third party. The online event can be within a company or business, or outside. After the event is over, the users can provide feedback right after the online event or after a period of time (e.g., after finding out some more information requested by the third party.

Further, a guest list can be created by working with the client or brand and defining the consumer target and scope for specific event. The list of invitees can be drawn from, e.g., the brand's website, Facebook® page, brand's CRM data base, brand celebrity Facebook® pages, invitees inviting friends, relevant bloggers inviting their communities, and/or a particular database where attendees may have opted into an invitee list. When dealing with multi-brands, each sponsor's lists can be incorporated into the guest list.

When creating the online event, each particular event can be customized. While basic components can remain constant, each event can be developed to be highly customized with brand-focused strategic/creative content as the centerpiece. New original content can be created as needed for an event, and/or content can be edited/modified for an existing event. The look and sound of the “venues” will be customized accordingly. Alternative event approaches can be presented to the sponsor and a course of action can be determined for a series of events. All existing sponsor content can be evaluated to determine possible usage for the event. If celebrity usage and/or original footage are involved, the production companies/editors are worked with to insure that the material is crafted for the online audience/experience. If material can be utilized from an outside content creator, then the creator and the client can be consulted with and brought to the event.

The overall “look” for the event can be a photo-realistic rendering, with a unique illustrative texture. Each event can have an appropriate background musical soundtrack and crowd “buzz”, to simulate what one might expect at a real event. Each event can feel intimate, exclusive and not be overwhelming to the guest. Many “duplicate” events can be simultaneously run to achieve that intimacy, and events can be scheduled by time zones, etc. so that the event can be accessible to all. Voice recognition can be provided for the users and the third party so manual entry may not be necessary for chats and interactivity. In some exemplary embodiments, a virtual reality system can be implemented so that the one or more users can wear a headset so that they feel that they are in the “room” attending the online event.

The initial invitation, stating premise, date and time of the event can be sent via email to any/all of the target(s) above, from, e.g., the sponsor's name. Invited guests can have the capacity to extend invitation on their behalf to friends. The exemplary system of the present disclosure can handle all aspects of this communication. Follow up email “reminders” and calendar events can be sent leading up to the event date. Clicking on a link to RSVP can take invitees to the registration page.

The invitees can register on a website of the exemplary system of the present disclosure or on a social networking site, such as Facebook®. All of the invitees' information provided on the networking site can be secured for guest wall connections. The registration webpage can be a basic, user-friendly format, and can be customizable. Guests who do not have an account on the social networking site can also register. Once registered, guests can be prompted to go directly to a welcome page.

Once the invitee(s) register, engagement with the particular invitee can be initiated. The welcome page can be a mini-site that can live within a brands social networking page, such as the brand's Facebook® page or as its own micro site. This page can preview some of the video features of the upcoming online event, request additional information/questions to enhance the guest's experience, can give guests the opportunity to submit questions and content for the actual event, provide access to available product samples and discounts, provide calendar reminders and countdowns to the event, and/or also provide the opportunity to invite friends to the online event.

During the time of the actual online event, a pre-taped or live concierge, which can be shot against a green screen and laid into the graphics of the site, can be stationed in, e.g., an empty main room shown on the site. The concierge can greet guests to provide a tutorial for the event experience. The concierge can explain what will take place over the course of the event. This can include how to find other guests and how to converse with them via text or video chat. It can also include instructions for how to enter other “rooms” as well as how to download materials. Upon the conclusion of the event the concierge may appear again to remind people to pick up their “swag bags” and opt-in to future events based on their interests and/or other information provided. The “swag bags” can be sponsor related items, such as coupon booklets or other product information. The concierge can be a person, depiction, cartoon, animal, etc.

Once guests enter the “main room” during the event, which can be personalized to the sponsor's tastes and specification (e.g., a lounge room, kitchen, stadium, etc.), the main room can be populated with pictures of the guests or attendees, such as the Facebook® profile pictures. Pictures can appear of guests that are registered, who are currently in the main room, or only of guests who are also the user's “friends” on the social networking site. Guests can search for other guests by scrolling through all the guests, or filtering by categories such as invited friends, social media friends, friends of friends, and/or other appropriate filters that can be used to connect people to each other through like-minded shared interests/behaviors. To learn more about guests, full profiles of guests can be seen, such as their Facebook® profile.

Users can have conversations with one or more people. When a guest chooses or finds someone to converse with, the guest can, e.g., click on the profile of another guest. Guests can have an option to converse via text or video chat. Group chats via text or video can also take place.

The main room shown on the site during the event can contain a wall on which all guests get to weigh in on topics asked by the brand or sponsor, and/or preprogrammed to be asked by the site. Guests can also ask questions/pose topics for all guests via a “Shout Out” function, which allows a user to type a question on an interactive “chat wall”.

The main room and all other rooms shown during the event site can contain links to all social media platforms, such as Facebook®, Twitter®, Pinterest®, YouTube®, etc. so the attendees can communicate their experiences to their friends and share it on the platform. A demonstration area can be provided on the website during the event where guests or attendees can view a demonstration. The demonstration can be chosen by the guest out of several video-taped demonstrations relevant to the brand, and information relevant to the demonstration can be shown or be separately downloadable by the attendee.

A broad range of entertainment for guest viewing can also be provided. It may be live or embedded videos. This entertainment can be original content, brand content, third party content or user-generated content. Capability for interactive live questions and answers, as well as voting capabilities, can be built-in. Individual or team activities (e.g., trivia, Karaoke) can be conducted around brand specific themes that are created. An area can also be provided for brands to sell merchandise. There can be a link to the brand's commerce website or a special web page can be provided for special offerings provided by the brand conducting the event. In this area, brands can also test packaging, merchandising and/or advertising options. Specific questions can be asked before, during and/or after the online event.

Once the event is over or about to be over, the concierge can thank the guests for attending, and guests can be given an opportunity to download “Swag Bags” that provide free brand focused merchandise, samples, products, coupons and/or offers. Guests will also be given an opportunity to opt-in to other events via a questionnaire.

After an event is completed, a micro-site can be created. All content, including video and all information provided during the event, can be repurposed by the brand and be transmitted wherever the brand chooses. In addition, continuing forums can be conducted among attendees who opt in. Brands can choose from several ways to continue the engagement if they choose.

Providing such events online as described above can also serve as a very valuable research tool and a “living focus group”. Brand or researchers can conduct research prior to the event via the RSVP list and social media (e.g., Facebook®) information. Researchers can segment across multiple vectors to create customized qualitative research, and given the sample size, some quantitative research as well. Brands can conduct surveys, create face-to-face dialogue, and create a panel for future research follow-up. Advertising, packaging and merchandising options can be tested.

Further, Google® analytics can be captured. Time spent on each of the activities can be recorded. Downloads and “Swag Bag” redemption can also be recorded. Transcripts of brand-relevant conversations can be monitored and recorded.

The exemplary embodiments of the present disclosure are not limited to what is described herein. The exemplary embodiments of the present disclosure provide for a method where a brand's needs are taken into consideration when offering an event to address these needs. Further, the event can be an “invite-only” event that is curated exclusively for those who share common interest, backgrounds, etc. The exemplary embodiments of the present disclosure also provide for a “social chat” via text and/or video, real-time scheduled events, brand/category generated content, user generated content, live capabilities for interactive questions and answers, etc., demonstration areas (videos and/or live), brand themed games/activities, commerce opportunities (e.g., testing of packaging, commercials, merchandising ideas) and “swag bags” which can be downloadable content that provide perks/benefits to the attendees. The exemplary embodiments of the present disclosure also provide for an environment that provides a unique look, sound and vibe that reflects a real world event.

Various other considerations can also be addressed in the exemplary applications described according to the exemplary embodiments of the present disclosure. Various real-time data can be provided such as but not limited to audio, video, text, files, etc. The exemplary embodiments of the present disclosure can be used in various configurations and in different systems. Various computing arrangements can be provided, having a processor(s) configured or programmed to perform the exemplary steps and/or procedures of the exemplary embodiments of the present disclosure described above. Various data described above can be stored in various storage arrangements (e.g., hard drive, memory device, such as RAM, ROM, memory stick, floppy drive, and other tangible computer-accessible medium, etc.). The processor(s) can access the storage arrangement(s) to execute a computer program or a set of instructions (stored on or in the storage arrangement) which can perform the procedures according to the exemplary embodiments of the methods and systems of the present disclosure.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure. The disclosures of all documents and publications cited herein are hereby incorporated herein by reference in their entireties.

What is claimed is:

1. A method of providing an online event, comprising:
configuring a server to allow one or more users access to an online event having a specific date and time;
configuring the server to allow a third party to provide event information to the one or more users related to the online event; and
providing the event information from the third party to the one or more users regarding the online event at the specific date and time.

2. The method according to claim 1, further comprising:
configuring the server to provide the third party an ability to interact with the one or more users during the online event at the specific date and time.

3. The method according to claim 1, further comprising:
configuring the server to allow the third party to provide event information prior to the online event; and
storing the event information in a database.

4. The method according to claim 3, further comprising:
providing the event information to the one or more users from the database prior to the online event.

5. The method according to claim 1, further comprising:
configuring the server to allow the one or more users to register for the online event before the online event takes place.

6. The method according to claim 5, wherein profile information for the one or more users can be generated from one or more social media sites.

7. The method according to claim 1, wherein the one or more users can interact with each other through text, audio and/or video before, during and after the online event.

8. The method of claim 1, further comprising:
providing reward information to the one or more users for a particular user after the online event has taken place.

9. The method of claim 1, wherein the third party is a company and the online event is regarding a product of the company.

10. A system for providing an online event, comprising:
a database for storing information relating to one or more users and an online event having a specific date and time; and
a server for receiving event information from a third party relating to the online event and for providing the one or more users the event information from the third party at the specific date and time.

11. The system according to claim 10, wherein event information from the third party is stored in the database prior to the online event.

12. The system according to claim 11, wherein the server provides the event information from the database to the one or more users prior to the online event.

13. The system according to claim 10, wherein the server allows the one or more users to interact with each other through text, audio and/or video before, during and after the online event.

14. The system according to claim 10, wherein the database stores profile information relating to the one or more users from one or more social media sites.

15. The system of claim 10, wherein the server provides reward information relating to the online event after the online event has taken place.

16. The system of claim 10, wherein the server provides the third party an ability to interact with the one or more users during the online event at the specific date and time.

17. A computer-accessible medium which contains thereon software for providing an online event, wherein, when a processing arrangement executes the software, the processing arrangement is configured to perform procedures comprising:
configuring a server to allow one or more users access to an online event having a specific date and time;
configuring the server to allow a third party to provide event information to the one or more users related to the online event; and
providing the event information from the third party to the one or more users regarding the online event at the specific date and time.

18. The computer-accessible medium according to claim 17, wherein the processing arrangement is further configured to:
provide the third party an ability to interact with the one or more users during the online event at the specific date and time.

19. The computer-accessible medium according to claim 17, wherein the processing arrangement is further configured to:
allow the third party to provide event information prior to the online event; and
store the event information in a database.

20. The computer-accessible medium according to claim 19, wherein the processing arrangement is further configured to:
provide the event information to the one or more users from the database prior to the online event.
